(19) United States
(12) Patent Application Publication
(10) Pub. No.: US 2021/0343460 A1
(43) Pub. Date: Nov. 4, 2021

(54) Method for preparing metallic magnetic powder core integrated chip inductor

(71) Applicant: Chuangyi Technology (Shaoshan) Co., Ltd., Shaoshan (CN)

(72) Inventors: Liliang Su, Shaoshan (CN); Lifeng Su, Shaoshan (CN); Shuhua Song, Shaoshan (CN); Liqing Huang, Shaoshan (CN); Mingsong Liu, Shaoshan (CN); Qingshou Long, Shaoshan (CN); Yu Liu, Shaoshan (CN); Xueyuan Su, Shaoshan (CN)

(73) Assignee: Chuangyi Technology (Shaoshan) Co., Ltd.

(21) Appl. No.: 17/324,060

(22) Filed: May 18, 2021

(30) Foreign Application Priority Data
Oct. 19, 2020 (CN) 202011114582.8
Feb. 2, 2021 (CN) 202110139477.8

(51) Int. Cl. H01F 3/08; C25D 7/00; C25D 3/38; C25D 3/12

(52) U.S. Cl. CPC H01F 3/08; C25D 3/12; C25D 3/38; C25D 7/001

(57) ABSTRACT

A method for preparing a metallic magnetic powder core integrated chip inductor, includes steps of: winding a spiral coil, compression molding, chamfering, curing, insulation coating, grinding, electrode copper plating. The integrated chip inductor of the present invention iterates the current industry's technology of paste-terminated electroplating integrated inductors, copper chip terminal electrode integrated inductors, and built-in T-shaped magnetic core pendulum winding electrode products, thereby reducing the installation size of the product on the circuit board increases the installation space of the integrated circuit PCB board. The present invention can realize intelligent manufacturing, achieve resource saving and environmental friendliness, and can create unique value for the development of the world's electronic industry.

### CROSS REFERENCE OF RELATED APPLICATION

The present application claims priority under35 U.S.C. 119(a-d) to CN 202011114582.8, filed Oct. 19, 2020 and CN202110139477.8, filed Feb. 2, 2021.

### BACKGROUND OF THE PRESENT INVENTION

### Field of Invention

The present invention relates to inductor structure, and more particular to a method for preparing a metallic magnetic powder core integrated chip inductor

### Description of Related Arts

The conventional structure of integrated inductors include paste-terminated electroplating type, copper piece end electrode type and T-core electrode type; however, the paste-terminated electroplating type is relatively small in size, when mounted on the chip, the side tin stacking area is large, which reduces the electronic components density on integrated circuits and wastes the space of the circuit board. Meanwhile, the paste-terminated electroplating type has 4 metal layers in the electrode welding area of the body, which are copper/silver/nickel/tin. Parasitic capacitance is easily formed among the 4 metal layers, which increases the DC resistance and reduces the self-resonant frequency when the inductor welded. The lead frame of the material spot welding electrode type one-piece inductor is bent from the side of the product to the bottom. The bending amplitude and the thickness of the frame will make the length of the product longer and limit designing of the coil, leading to a result that the product characteristics is limited, which not only wastes the space of the circuit board but also reduces the density of integrated circuits as well. The productive investment of the T-core electrode type integrated inductor is high and the output is low, thus, the manufacturing cost of the product is very high, which is not conducive to mass production and difficult to rapidly meet the demands of the market.

### SUMMARY OF THE PRESENT INVENTION

The purpose of the present invention is to provide a type that only retains the bottom electrode or “L”-shaped electrode and adopts insulating coating. The metal powder core integrated chip inductor of this invention iterates the paste-terminated electroplating type integrated inductor and copper in the current industry. The technology of chip terminal electrode type integrated inductors and built-in T-shaped magnetic core pendulum on wire-wound electrode type products, thereby reducing the installation size of the product on the circuit board, increasing the installation space of the integrated circuit PCB board, and contributing to the integrated circuit industry The highly integrated development creates favorable conditions; the overall performance of the product is greatly improved under the same size.

In order to achieve the above objective, the technical solution provided by the present invention is as follows. A method for preparing a metallic magnetic powder core integrated chip inductor, comprises steps of: winding a spiral coil, compression molding, chamfering, curing, insulation coating, grinding, electrode copper plating.

Preferably, the method for preparing the metallic magnetic powder core integrated chip further comprises steps of: winding a hollow spiral coil, compression molding, green body chamfering, hot pressing curing, heated billet chamfering, primary nano-insulation coating, primary grinding, electrode nickel plating, electrode copper plating, secondary nano-insulation coating, secondary grinding, electroplating metalized electrode, and testing packaging.

Preferably, the winding of the coil is multi-axis winding on a winding jig to form a hollow coil.

Preferably, the compression molding is performed by placing a wire winding jig containing a coil into a mold of a molding machine, and then implanting the coil into the mold at a fixed point The cavity is filled with metal powder for stamping and forming products.

Preferably, the chamfering is a molded product, mixed with a chamfering medium in a certain proportion according to the weight of the product, and then placed into the chamfer. The equipment completes the chamfering operation.

Preferably, the curing is to place the product neatly typeset into a curing device cavity for curing and forming.

Preferably, the insulation coating is to perform insulation coating treatment on the surface of the product.

Preferably, the grinding is to arrange the products neatly into a jig, use a grinder to perform grinding operations on the products, and expose the end of the product after grinding. Section of enameled copper wire.

Preferably, the electroplating includes electroplating nickel, electroplating aluminum, electroplating copper, electroplating silver, electroplating magnesium, electroplating molybdenum, electroplating manganese, One or more of electroplating zinc, electroplating titanium, electroplating cobalt, electroplating vanadium, electroplating chromium, electroplating steel, electroplating tin, and electroplating gold.

These and other objectives, features, and advantages of the present invention will become apparent from the following detailed description, the accompanying drawings, and the appended claims.

### BRIEF DESCRIPTION OF THE DRAWINGS

FIG. 1 is a process flow diagram of the present invention.

FIG. 2 is a comparison diagram of the load current characteristics of the present invention and the marketed products.

FIG. 3 is a comparison diagram of the characteristics of the present invention and marketed products.

FIG. 4 is the measured data of the characteristics of the product of the present invention.

FIG. 5 is a schematic diagram of the bottom electrode product of the present invention.

FIG. 6 is a schematic diagram of the “L”-shaped electrode product of the present invention.

FIG. 7 is a front X-ray perspective view of the product of the present invention.

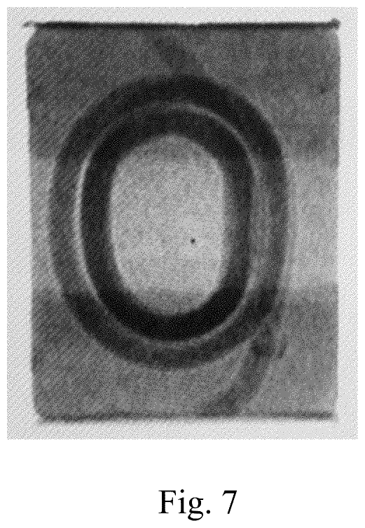

FIG. 8 is a side X-ray perspective view of the product of the present invention.

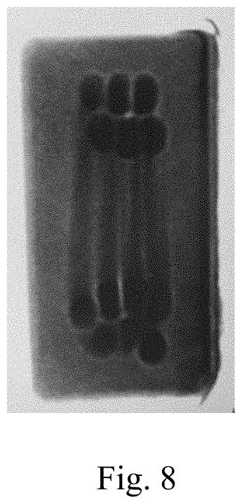

FIG. 9 is a data chart of the aging load test of the present invention.

FIG. 10 is a data chart of solderability of the present invention.

FIG. 11 is a data chart of the heat weldability of the present invention.

FIG. 12 is a graph of thrust test data of the present invention.

FIG. 13 is a graph of the 100 grid test data of the present invention.

FIG. 14 is a graph of the hydrochloric acid test data of the present invention.

FIG. 15 is a high-temperature storage data chart of the present invention.

FIG. 16 is a data chart of the steam aging test of the present invention.

FIG. 17 is a graph of the metallographic section test data of the present invention.

FIG. 18 is a graph of the interlayer test data of the present invention.

### DETAILED DESCRIPTION OF THE PREFERRED EMBODIMENT

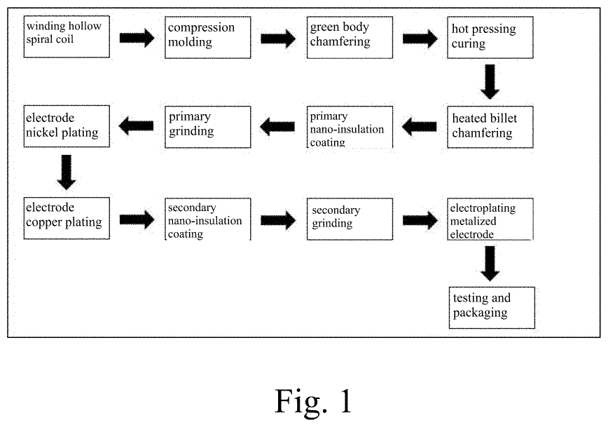

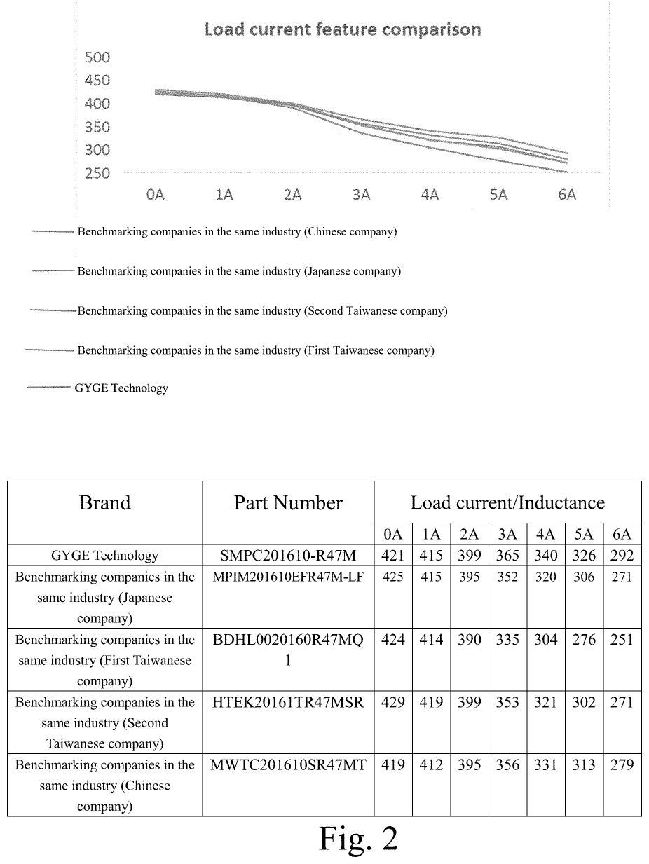

The present invention will be further explained below in conjunction with all the drawings. Referring to the FIGS. 1-5, preferred embodiments of the present invention is as follows.

Hereinafter, the present invention will be further described in conjunction with all the drawings. Referring to FIGS. 1 to 5, the preferred embodiments of the present invention are:

### Example 1: The Bottom Electrode is Prepared in this Example

The preparation method of the metal powder core integrated chip inductor includes the following steps: winding a hollow coil, compression molding, raw embryo chamfering, hot pressing curing, cooked embryo chamfering, insulation coating, grinding, electrode nickel plating, electrode copper plating, two Secondary insulation coating, secondary grinding, electroplating metalized electrodes, testing packaging.

The first step: winding the hollow coil: The hollow coil is made according to the product specifications; the winding method is multi-axis winding on the winding jig, which must meet the corresponding technical standards. The selection and winding of enameled copper wire have been repeatedly tested, and have obtained winding equipment parameters and wire specification data that can be mass-produced. The winding method adopts multi-axis winding on the winding jig, which can increase the winding speed while saving material.

The second step: compression molding: using carbonyl iron powder or alloy materials (iron-silicon, iron-silicon-chromium, iron-nickel, iron-silicon-aluminum and amorphous nano-material systems), the R&D team has gone through many experiments, recorded data, and statistics After analysis, the best carbonyl powder ingredient formula was selected as follows:

Mix the carbonyl iron powder/alloy material: epoxy resin: acetone according to the weight ratio of 100:≤7:≤20, and then keep it at a temperature of ≤80° C. for 1-3 hours, and then grind and granulate to prepare the powder It needs to meet the sphericity 60%, and the powder particle size meets: D50≤30 μm, D90≤90 μm, D10≤20 μm; (D10 is the particle size whose cumulative distribution is 10%, that is, the volume content of particles smaller than this size account for all For 10% of the particles, D50 is the particle size at which the cumulative distribution of particles is 50%. Also called the median diameter or median particle size, this is a typical value indicating the size of the particle size. D90 is the particle size at which the cumulative distribution of particles is 90%. That is, the volume content of particles smaller than this size accounts for 90% of all particles.) Epoxy resin is used as a binder, and zinc stearate, barium stearate or other mold release lubricants are added after the powder granulation is completed;

Put the winding jig containing the hollow coil into the mold of the molding machine, and then implant the coil at a fixed point in the mold cavity, and fill the mold cavity with metal powder for stamping and forming products with a density of not less than 3 g/cm³.

Selection of the specific pressure of the molding machine: If the pressure is too high, it will scratch or crush the patent leather of the coil. If the pressure is not enough, the density of the produced product will be insufficient, which will cause defects such as missing corners and low inductance of the product. After a large number of tests, statistical data The parameters that can meet the best product quality, production efficiency and yield rate are screened out.

The third step: raw embryo chamfering: add no less than one thousandth of the chamfering medium to the molded product according to the weight of the product, and then put it into the chamfering equipment to complete the chamfering operation, the chamfering time is not less than 5 minutes, as described The chamfering medium is one or more of high-density and high-hardness powders such as alumina, zirconia, and silicon carbide.

The fourth step: hot pressing curing: put the product neatly typeset into the cavity of the hot pressing equipment, the temperature of the cavity of the hot pressing equipment is controlled not less than 100° C., and the pressure of not less than 0.5 MPa is used to hold the pressure for not less than 5 minutes Complete the hot-press curing operation.

Fifth step: Chamfering of cooked embryos: Add a chamfering medium greater than the weight of the product to the hot-pressed product according to the weight of the product, and then put it into the chamfering equipment to complete the chamfering of the cooked embryo. The chamfering time is not less than 5 minutes. The chamfering medium is a special chamfer stone (such as one or more of high-density and high-hardness particles such as granular zirconia, granular alumina, etc.).

The sixth step: insulation coating: use polyimide-based materials to perform insulation coating treatment on the surface of the product, and the thickness of the insulation layer is not less than 3 um. After the product is coated, bake at 100° C. for more than 0.5 hours to cure the insulation layer.

Seventh step: Grinding: Arrange the products neatly into the fixture, and use a high-precision grinder to grind the products. The unilateral grinding of the products is not less than 3 um, and the enameled copper wire section of the end of the product is exposed after grinding.

The eighth step: Electrode nickel plating: electroplating the polished product with a nickel layer not less than 0.3 um.

The ninth step: Electrode copper plating: electroplating a nickel-plated product with a copper layer of not less than 1 um.

The tenth step: secondary insulation coating: use polyimide-based nanomaterials to conduct insulation coating treatment on the surface of the product. The thickness of the insulation layer is not less than 3 um. After the product is coated, it is cured at a temperature above 100° C. for more than 0.5 hours Insulation.

The eleventh step: secondary grinding: Arrange the products neatly into the fixture, and use a high-precision grinder to grind the products. The unilateral grinding of the products is not less than 3 um and the copper conductor coating at the bottom of the product is exposed.

The twelfth step: electroplating metallized electrode: the product adopts vacuum coating process (PVD technology), one or two of the traditional electroplating process, and adds the required metal on the surface of the nickel-plated copper layer And alloy material coating, said metal is an alloy formed by one or more of nickel, aluminum, copper, silver, magnesium, molybdenum, manganese, zinc, titanium, cobalt, vanadium, chromium, steel, tin, and gold Material plating to increase the solderability, solder resistance and adhesion of the product.

The thirteenth step: inspection and packaging: the products are inspected to eliminate defective products in size, appearance and characteristics, and then packaging.

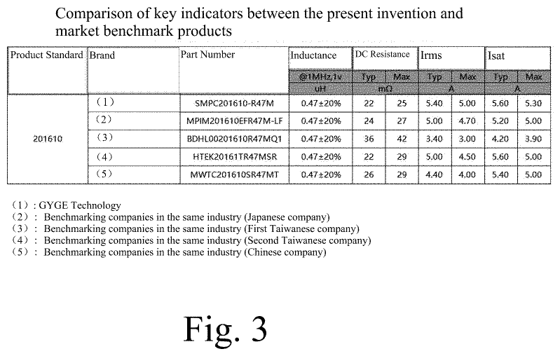

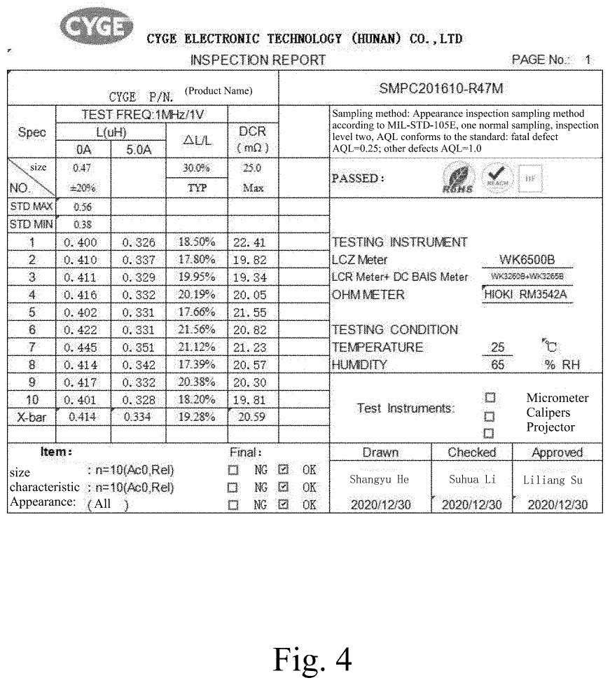

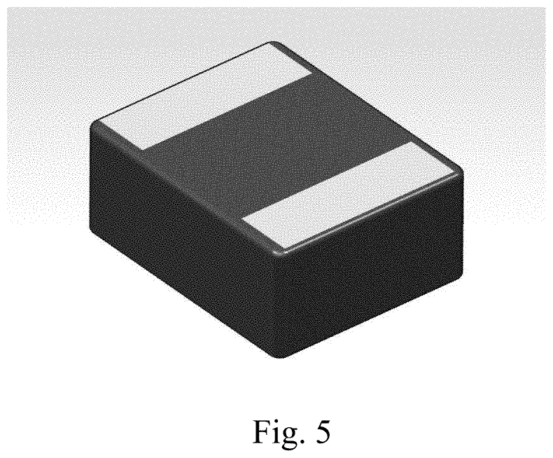

Refer to FIG. 4 for the actual measurement data of the product made according to the above process, refer to FIG. 5 for the schematic diagram of the product made according to the above process, and compare the characteristics of the products of the market benchmark enterprise (FIG. 3), and comprehensively compare the load current of the product of the application, Working current, energy loss are significantly better than peer benchmarking enterprise products.

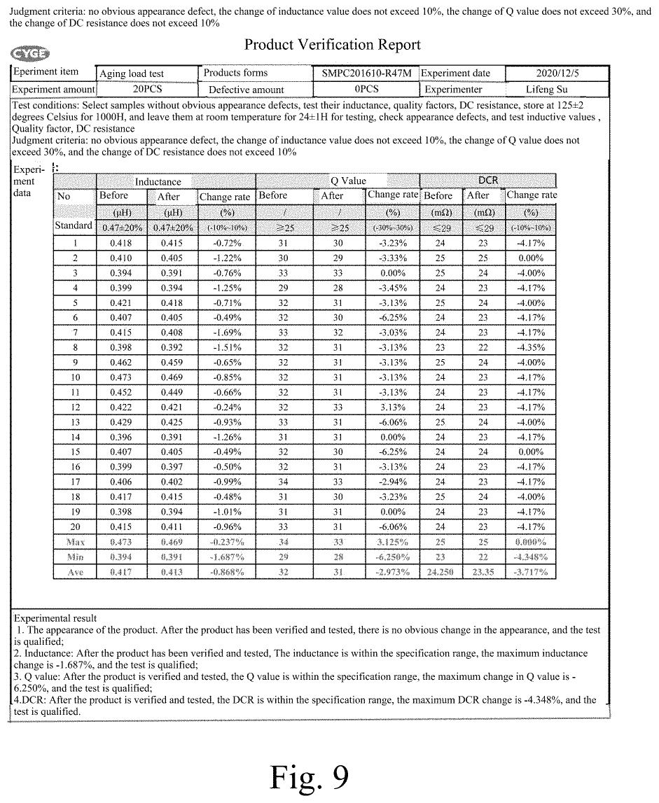

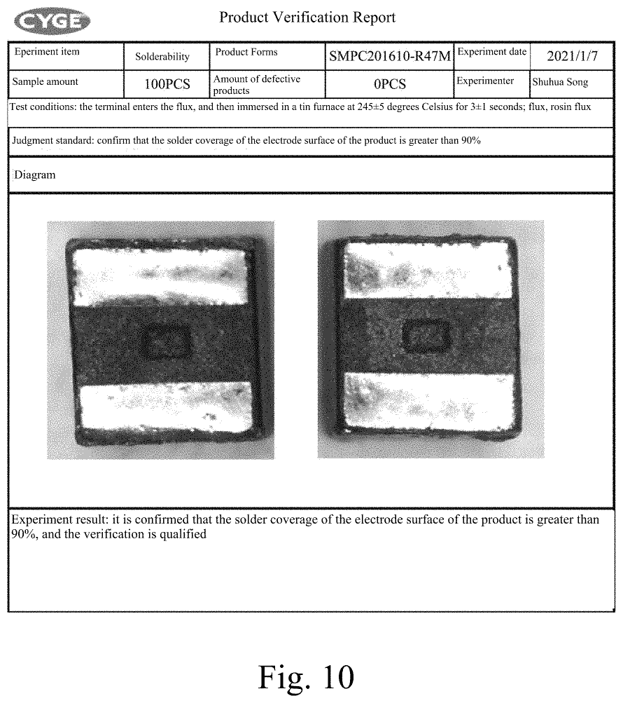

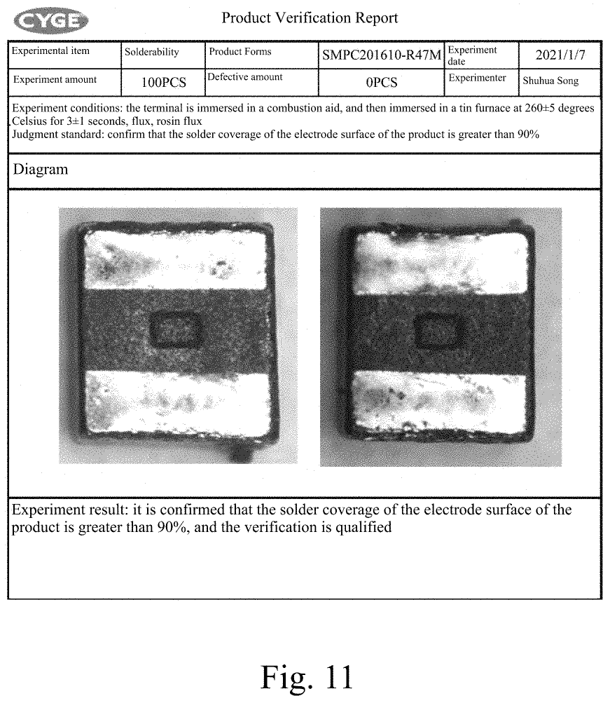

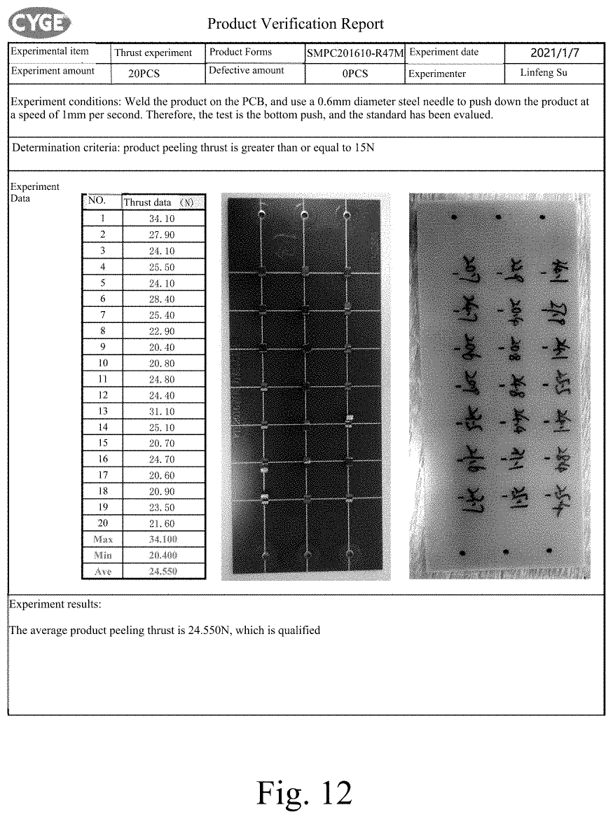

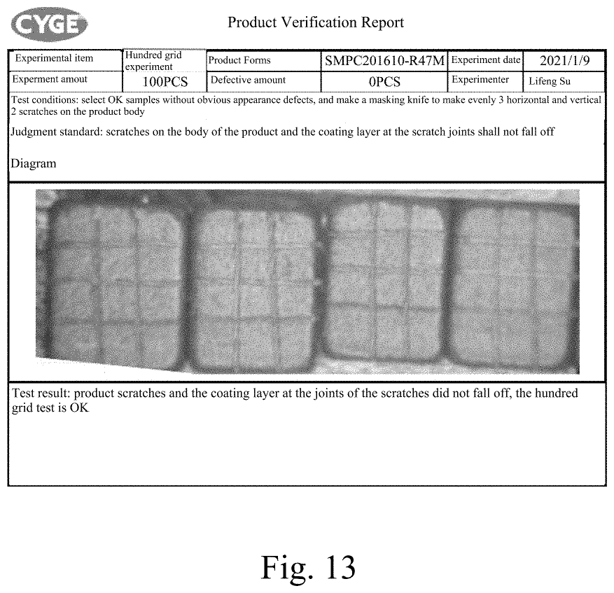

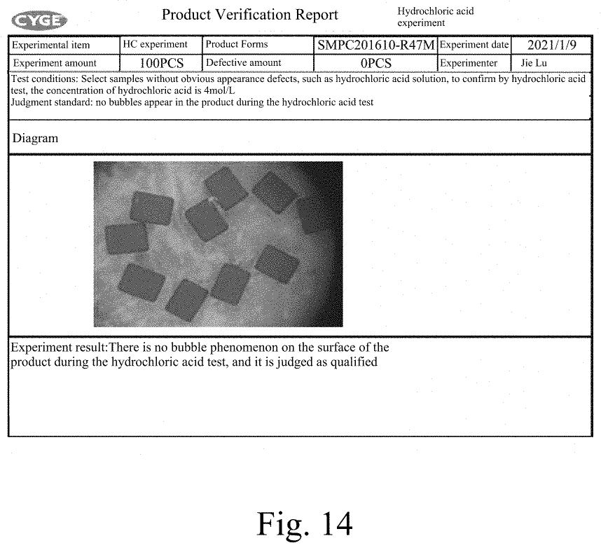

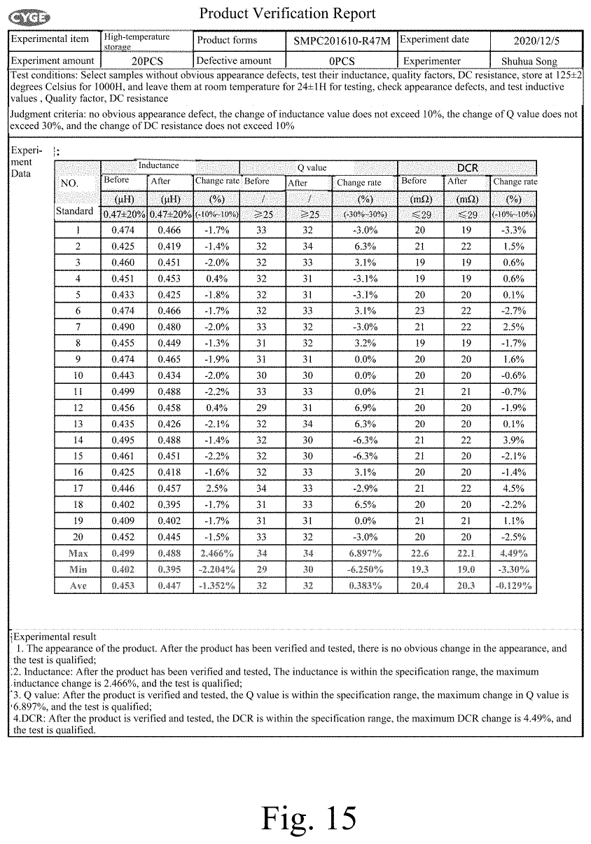

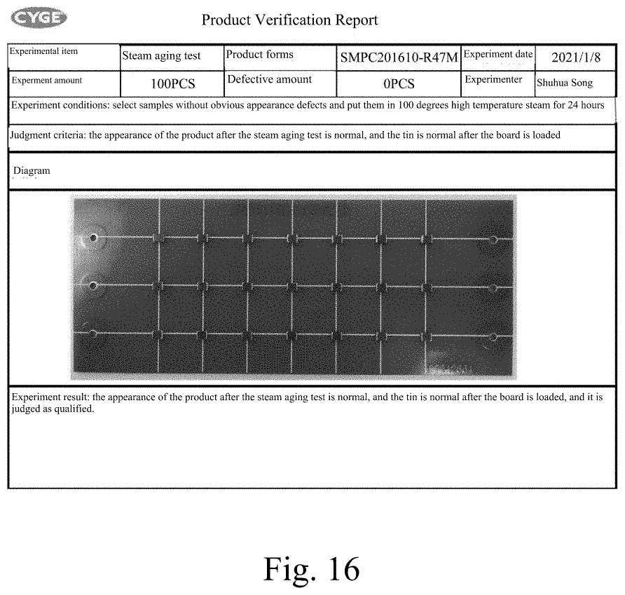

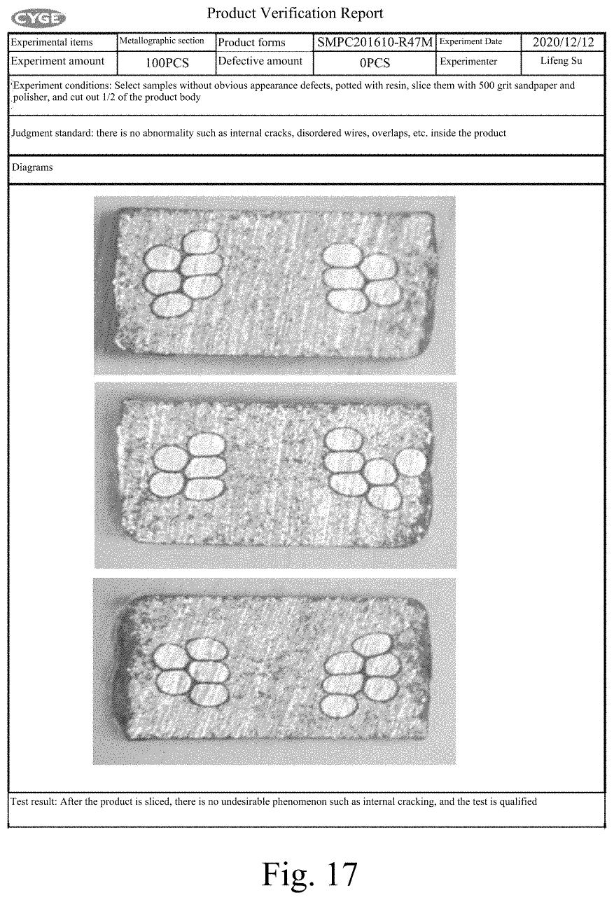

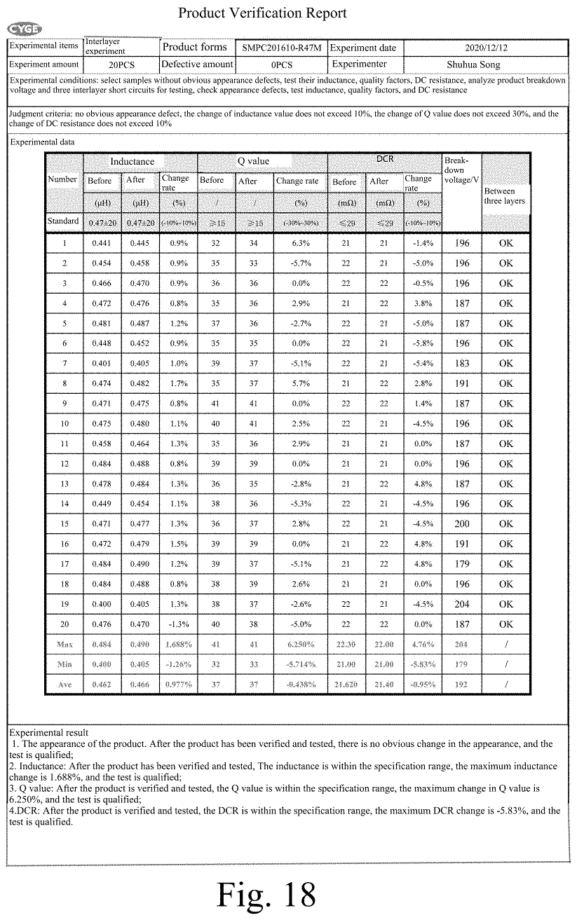

The test data of the products made according to the above process are shown in FIG. 9 to FIG. 18.

### Example 2: The “L-Shaped” Electrode Prepared in this Example

The preparation method of the metal powder core integrated chip inductor includes the following steps: winding a hollow coil, compression molding, raw embryo chamfering, hot pressing curing, cooked embryo chamfering, insulation coating, grinding, electroplating, inspection and packaging.

The first step: Winding the hollow coil: The hollow coil is made according to the product specifications; the winding method is multi-axis winding on the winding jig, which must meet the corresponding technical standards. The selection and winding of enameled copper wire have been repeatedly tested, and have obtained winding equipment parameters and wire specification data that can be mass-produced. The winding method adopts multi-axis winding on the winding jig, which can increase the winding speed while saving material.

The second step: compression molding: using carbonyl iron powder or alloy materials (iron-silicon, iron-silicon-chromium, iron-nickel, iron-silicon-aluminum and amorphous nano-material systems), the R&D team has gone through many experiments, recorded data, and statistics After analysis, the best carbonyl powder ingredient formula was selected as follows:

The carbonyl carbonyl iron powder/alloy material: epoxy resin: acetone is mixed uniformly according to the weight ratio of 100:≤7:≤20, and then kept at a temperature of ≤80° C. for 1-3 hours, and then grind and granulate. The powder needs to meet the sphericity ≥60%, and the powder particle size meets: D50≤30 μm, D90≤90 μm, D10≤20 μm; (D10 is the particle size whose cumulative distribution of particles is 10%, that is, the volume content of particles smaller than this size 10% of all particles, D50 is the particle size at which the cumulative distribution of particles is 50%. Also called the median diameter or median particle size, this is a typical value indicating the size of the particle size. D90 is the particle size at which the cumulative distribution of particles is 90%, i.e., the volume content of particles smaller than this size accounts for 90% of all particles.) Epoxy resin is used as a binder, and zinc stearate, barium stearate or other mold release lubricants are added after the powder granulation is completed;

Put the winding jig containing the hollow coil into the mold of the molding machine, and then implant the coil at a fixed point in the mold cavity, and fill the mold cavity with metal powder for stamping and forming products with a density of not less than 3 g/cm³.

Selection of the specific pressure of the molding machine: If the pressure is too high, the patent leather of the coil will be scratched or crushed. If the pressure is not enough, the density of the produced product will be insufficient, which will cause defects such as missing corners and low inductance. The parameters that can meet the best product quality, production efficiency and yield rate are screened out.

The third step: raw embryo chamfering: add no less than one thousandth of the chamfering medium to the molded product according to the weight of the product, and then put it into the chamfering equipment to complete the chamfering operation, the chamfering time is not less than 5 minutes, as described The chamfering medium is one or more of high-density and high-hardness powders such as alumina, zirconia, and silicon carbide.

The fourth step: hot pressing curing: put the product neatly typeset into the cavity of the hot pressing equipment, the temperature of the cavity of the hot pressing equipment is controlled not less than 100° C., and the pressure of not less than 0.5 MPa is used to hold the pressure for not less than 5 minutes Complete the hot-press curing operation.

Fifth step: Chamfering of cooked embryos: Add a chamfering medium greater than the weight of the product to the hot-pressed product according to the weight of the product, and then put it into the chamfering equipment to complete the chamfering of the cooked embryo. The chamfering time is not less than 5 minutes. The chamfering medium is a special chamfer stone (such as one or more of high-density and high-hardness particles such as granular zirconia, granular alumina, etc.).

The sixth step: insulation coating: use polyimide-based materials to perform insulation coating treatment on the surface of the product, and the thickness of the insulation layer is not less than 3 um. After the product is coated, bake at 100° C. for more than 0.5 hours to cure the insulation layer.

Seventh step: Grinding: Arrange the products neatly into the fixture, and use a high-precision grinder to grind the products. The unilateral grinding of the products is not less than 3 um, and the enameled copper wire section of the end of the product is exposed after grinding.

The eighth step: the first electroplating: the polished product is electroplated with a nickel base by a traditional process, and the thickness of the plating layer is not less than 0.3 um to increase the adhesion of the electrode.

The ninth step: the second electroplating: on the basis of the nickel-plated base, the copper layer is electroplated by the traditional process, and the thickness of the plating layer is not less than 1.0 um, which increases the conductivity.

The tenth step: the third electroplating: the copper-plated products are electroplated with a tin layer by a traditional process, the thickness of the plating layer is not less than 1.0 um, and the oxidation resistance and solderability are increased.

The eleventh step: inspection and packaging: the products are inspected to eliminate defective products in size, appearance and characteristics, and then packaging.

The electroplating process of this embodiment can also adopt one or a combination of vacuum coating process (PVD technology) and traditional electroplating process as required.

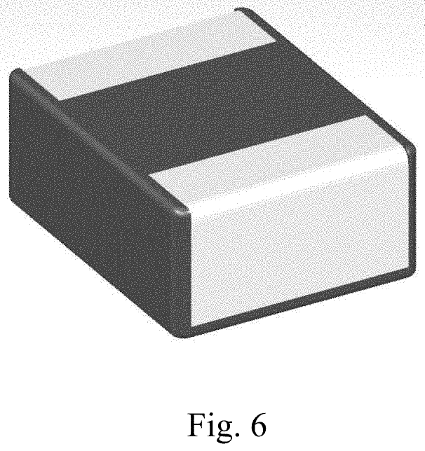

Refer to FIG. 6 for the schematic diagram of the product made according to the above process.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for preparing a metallic magnetic powder core integrated chip inductor, comprising steps of: winding a spiral coil, compression molding, chamfering, curing, insulation coating, grinding, electrode copper plating.

2. The method for preparing the metallic magnetic powder core integrated chip inductor, as recited in claim 1, comprising steps of: winding a hollow spiral coil, compression molding, green body chamfering, hot pressing curing, heated billet chamfering, primary nano-insulation coating, primary grinding, electrode nickel plating, electrode copper plating, secondary nano-insulation coating, secondary grinding, electroplating metalized electrode, testing and packaging.

3. The method for preparing the metallic magnetic powder core integrated chip inductor, as recited in claim 1, wherein the winding of the coil is multi-axis winding on a winding jig to form a hollow coil.

4. The method for preparing the metallic magnetic powder core integrated chip inductor, as recited in claim 1, wherein the compression molding is performed by placing a wire winding jig containing a coil into a mold of a molding machine, and then implanting the coil into the mold at a fixed point The cavity is filled with metal powder for stamping and forming products.

5. The method for preparing the metallic magnetic powder core integrated chip inductor, as recited in claim 1, wherein the chamfering is a molded product, mixed with a chamfering medium in a certain proportion according to the weight of the product, and then placed into the chamfer. The equipment completes the chamfering operation.

6. The method for preparing the metallic magnetic powder core integrated chip inductor, as recited in claim 1, wherein the curing is to place the product neatly typeset into a curing device cavity for curing and forming.

7. The method for preparing the metallic magnetic powder core integrated chip inductor, as recited in claim 1, wherein the insulation coating is to perform insulation coating treatment on the surface of the product.

8. The method for preparing the metallic magnetic powder core integrated chip inductor, as recited in claim 1, wherein the grinding is to arrange the products neatly into a jig, use a grinder to perform grinding operations on the products, and expose the end of the product after grinding. Section of enameled copper wire.

9. The method for preparing the metallic magnetic powder core integrated chip inductor, as recited in claim 1, wherein the electroplating includes electroplating nickel, electroplating aluminum, electroplating copper, electroplating silver, electroplating magnesium, electroplating molybdenum, electroplating manganese, One or more of electroplating zinc, electroplating titanium, electroplating cobalt, electroplating vanadium, electroplating chromium, electroplating steel, electroplating tin, and electroplating gold.
